(19) United States
(12) Patent Application Publication
(10) Pub. No.: US 2026/0244874 A1
(43) Pub. Date: Aug. 20, 2026

(54) NON-TRANSITORY COMPUTER READABLE MEDIUM AND CHATBOT APPARATUS

(71) Applicant: Honda Motor Co., Ltd., Tokyo (JP)

(72) Inventors: Tameaki Honda, Tokyo (JP); Kazuki Yoshigai, Tokyo (JP); Hiroshi Honda, Tokyo (JP)

(21) Appl. No.: 19/536,098

(22) Filed: Feb. 10, 2026

(30) Foreign Application Priority Data
Feb. 14, 2025 (JP) 2025-022087

(51) Int. Cl. G06F 40/35; G06F 16/3329; H04L 51/02

(52) U.S. Cl. CPC G06F 40/35; G06F 16/3329; H04L 51/02

(57) ABSTRACT

A chatbot program performs: acquiring user-specific information; receiving, from a user terminal, a query related to the vehicle via the user terminal; generating a prompt being an input sentence for a large language model to transmit to the large language model based on the query; receiving an original answer to the prompt from the large language model; generating answer information based on the original answer; and transmitting the answer information to the user terminal. The chatbot program generates the answer information based on the user-specific information while changing at least one of a breadth of a range of vocabulary, an amount, and a type of the answer information based on at least one of an amount of knowledge related to the vehicle, a vehicle possession history, a vehicle use situation, and a vehicle possession situation of the user.

### CROSS-REFERENCE TO RELATED APPLICATION

This application is based upon and claims the benefit of priority from Japanese Patent Application No. 2025-022087 filed on February 14, 2025, the content of which is incorporated herein by reference.

### BACKGROUND

### Technical Field

The present disclosure relates to a non-transitory computer readable medium storing a chatbot program and a chatbot apparatus.

### Related Art

The usefulness of a large language model (LLM) is being recognized in information processing tasks with increasing complexity and diversity. Furthermore, in recent years, a system that supports sales of a product to a customer using a mobile terminal such as a smartphone or a tablet terminal has been known (see, for example, JP 2021-144416 A).

Meanwhile, in a case where a customer desires to obtain information of various products, if the customer makes a uniform response to a question sent from the customer, the content of the response may be felt complicated and the satisfaction level may not be obtained or the response may be felt redundantly depending on the product knowledge and experience of the customer.

### SUMMARY

An aspect of the present invention is a non-transitory computer-readable storage medium storing a chatbot program configured to be executed by a computer, the chatbot program causes the computer to perform: acquiring, from a database, user-specific information, including information related to a vehicle and specific to the user; receiving, from a user terminal operated by the user, a query related to the vehicle input by the user via the user terminal; generating a prompt being an input sentence for a large language model to transmit to the large language model based on the query; receiving an original answer to the prompt from the large language model; generating answer information based on the original answer; and transmitting the answer information to the user terminal. The generating the answer information includes generating the answer information based on the user-specific information while changing at least one of a breadth of a range of vocabulary, an amount, and a type of the answer information based on at least one of an amount of knowledge related to the vehicle of the user, a vehicle possession history of the user, a vehicle use situation of the user, and a vehicle possession situation of the user.

Another aspect of the present invention is a chatbot apparatus including: a microprocessor; and a memory connected to the microprocessor. The microprocessor is configured to perform: acquiring, from a database, user-specific information, including information related to a vehicle and specific to the user; receiving, from a user terminal operated by the user, a query related to the vehicle input by the user via the user terminal; generating a prompt being an input sentence for a large language model to transmit to the large language model based on the query; receiving an original answer to the prompt from the large language model; and generating the answer information based on the original answer, generating answer information based on the user-specific information while changing at least one of a breadth of a range of vocabulary, an amount, and a type of the answer information based on at least one of an amount of knowledge related to the vehicle of the user, a vehicle possession history of the user, a vehicle use situation of the user, and a vehicle possession situation of the user. transmitting the answer information to the user terminal. The microprocessor is configured to perform: the generating the answer information including generating the answer information based on the user-specific information while changing at least one of a breadth of a range of vocabulary, an amount, and a type of the answer information based on at least one of an amount of knowledge related to the vehicle of the user, a vehicle possession history of the user, a vehicle use situation of the user, and a vehicle possession situation of the user.

### BRIEF DESCRIPTION OF THE DRAWINGS

The objects, features, and advantages of the present invention will become clearer from the following description of embodiments in relation to the attached drawings, in which:

FIG. 1 is a conceptual diagram for explaining a general configuration of a chatbot system;

FIG. 2 is a conceptual diagram illustrating an example of a data structure of a customer database;

FIG. 3 is a conceptual diagram illustrating an example of a data structure of user data stored in the customer database;

FIG. 4 is a block diagram illustrating functional blocks of a server and components connected to the server via a network; and

FIG. 5 is a flowchart illustrating general processing steps of a chatbot response process executed by a CPU of the server that provides chatbot services to users.

### DETAILED DESCRIPTION

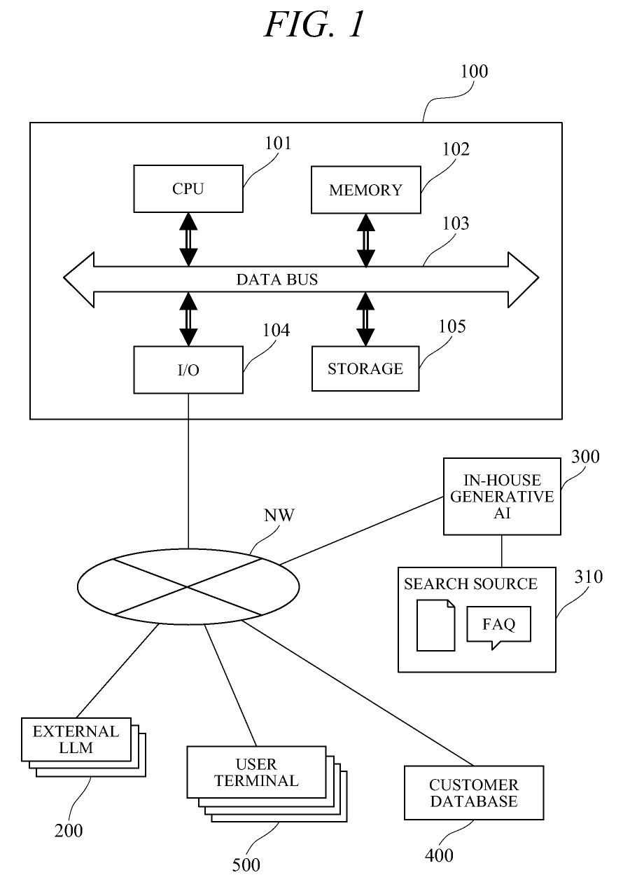

Hereinafter, an embodiment of the present disclosure will be described with reference to FIGS. 1 to 5. In all the drawings described below, common components are denoted by the same reference numerals, and repeated description is omitted. Note that not all the components shown in the following embodiments are essential components of the present disclosure.

FIG. 1 is a conceptual diagram for explaining a state in which a server 100 constituting a chatbot system is connected to an external LLM 200, an in-house generative AI system (In-house Generative AI) 300, a customer database (hereinafter also referred to simply as a database) 400, and a user terminal 500 via a network NW. In the present embodiment, the chatbot system is assumed to be a system that responds to questions from the user regarding vehicles such as passenger cars manufactured and sold by a company and services related to the vehicles.

The server 100 includes a CPU 101, a memory 102, an I/O 104, a storage 105, and a data bus 103 that enables data exchange between these elements.

A chatbot program for providing a chatbot service to the user is stored in, for example, the storage 105. The chatbot program may be read from the storage 105 when the server 100 is started, loaded into the memory 102, and executed by the CPU 101. Alternatively, the memory 102 may include a ROM, a flash memory, or the like, and a chatbot program stored in the ROM or the flash memory may be loaded into the memory 102 and executed by the CPU 101. In addition, a program obtained by being read from an optical disk drive device or a card reader (not illustrated) or being downloaded via the network NW may be loaded into the memory 102 and executed by the CPU 101.

Note that the server 100 can be virtually realized by providing all or a part of each hardware configuration in a distributed manner in a plurality of computers and connecting them to each other via the network NW or the like. That is, the server 100 is a concept including not only a server housed in a single housing or case but also a virtualized computer system.

The external LLM 200 is, for example, an LLM provided by a third party. The LLM (Large Language Model) is a large scale artificial intelligence model constructed by using a large set of text data and deep learning technologies, and used in the field of natural language processing (NLP). The LLM can learn a large amount of text data (web pages, books, articles, and the like) to understand patterns of languages used by humans and effectively perform natural language generation (NLG) tasks.

Hereinafter, the use of the LLM as an external source when providing a chatbot service to a user will be described as an example, but another external service utilizing AI, such as ChatGPT, Google Gemini (registered trademark), Cerence (registered trademark), or Claude3 (registered trademark), may be used.

An in-house generative AI system (hereinafter, also simply referred to as a generative AI system) 300 is a system that accumulates and constructs own information providing a chatbot service as a search source 310. The generative AI system 300 abundantly includes documents such as products and services sold and provided by the company and an operation manual accompanying the same, and information regarding a frequently asked question (FAQ) in the past, and can increase accuracy of an answer generated by AI and reduce hallucination. Furthermore, the generative AI system 300 can not only output a general answer to a question sent from the user who is driving the vehicle, but also make a more specific response such as "Please press the switch with a green design on the lower left among the plurality of steering switches provided on the right steering spoke". In addition, since the generative AI system 300 is a system of the company, it is advantageous in that an increase in cost can be suppressed even in a case where a transaction related to interaction with AI increases during execution of a chatbot session.

The customer database 400 is a database in which login information such as a password and user data to be described in detail later are accumulated in association with a user ID when the user logs in to the chatbot service.

The user terminal 500 is an information processing device operated by a user who uses a chatbot service provided by the server 100. For example, a smartphone, a tablet terminal, a personal digital assistant (PDA), a personal computer, or the like can be used as the user terminal 500, and an in-vehicle communication module can also be used as the user terminal 500.

The network NW for transmitting information between the elements described above can use the Internet. Note that the generative AI system 300, the customer database 400, and the server 100 may be connected via a closed network service not via the Internet, or may be connected using a virtual private network (VPN) technology. Alternatively, the generative AI system 300 and the customer database 400 may be included in the server 100. It is desirable to protect the customer database 400 using a strong encryption technology in order to enhance information security.

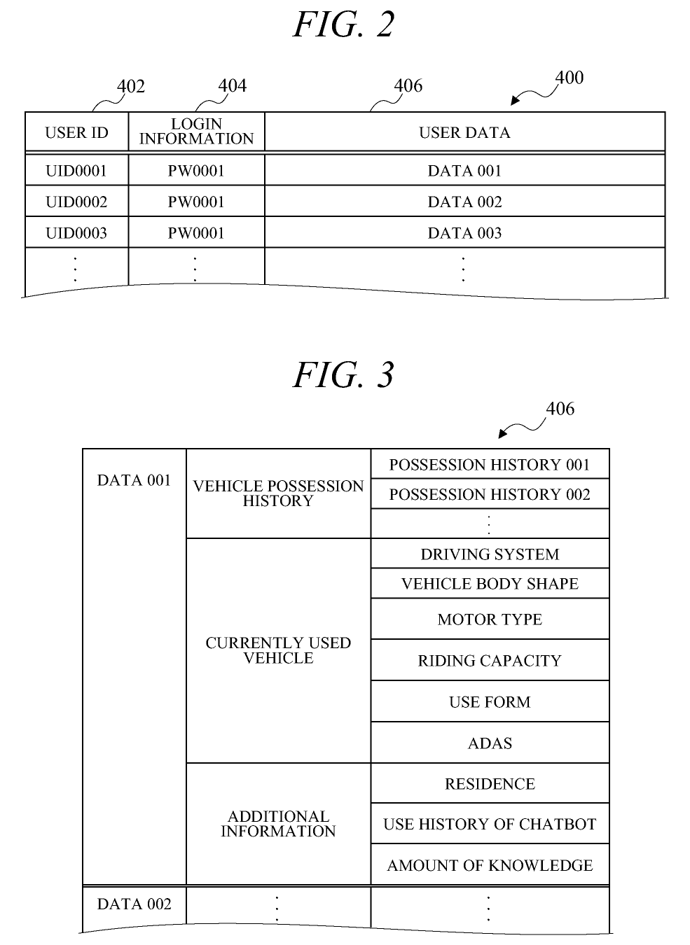

FIG. 2 is a conceptual diagram for schematically explaining a data structure of the customer database 400. The customer database 400 includes a user ID 402, login information 404, user data 406, and the like. The login information 404 and the user data 406 are accumulated in association with the user ID 402. The user ID 402 stores data to be referred to in collation with a user ID transmitted from the user terminal 500 at the start of a chatbot session to be described later. The login information 404 stores information such as a password corresponding to each user ID 402 and a past login date and time.

FIG. 3 is a conceptual diagram illustrating an example of information held as the user data 406. In the user data 406, information capable of specifying the amount of knowledge related to the vehicle of the user, a vehicle possession history of the user, a vehicle use situation of the user, a vehicle possession situation of the user, and the like is stored. The user data 406 further stores information regarding a question uttered by the user in a chatbot session performed in the past and an answer thereto, session information regarding each chatbot session, and the like.

Hereinafter, an example of information recorded as the user data 406 will be described with reference to FIG. 3. The information of the vehicle possession history includes information regarding a vehicle type owned by the user in the past, a possession period, a specification of the owned vehicle, and the like. The information on the currently used vehicle includes information on a driving system, a vehicle body shape, a motor type, a riding capacity, a use form, a function of advanced driver-assistance systems (ADAS), and the like. The additional information includes information regarding a residence of the user, a use history of the chatbot, the amount of knowledge regarding the vehicle, and the like.

The driving system information can include information that can specify F/F (front engine/front-wheel drive), F/R (front engine/rear-wheel drive), M/R (midship engine/rear-wheel drive), R/R (rear engine/rear-wheel drive), AWD (all-wheel drive), and the like.

The vehicle body shape information can include information on a box shape such as a sedan, a hood shape having a hood on a cargo bed, a station wagon including a hatchback, a wagon, a one-box car, and the like. As the vehicle body shape information, it is also possible to more finely classify and store SUVs, minivans, one-box cars, deck vans, off-road vehicles, light vehicles, light wagons, light vans, and the like.

The motor information can include information that can specify a gasoline engine, a diesel engine, a hydrogen engine that burns hydrogen to obtain power, a CNG engine that burns CNG (compressed natural gas) to obtain power, an HEV (hybrid vehicle using an internal combustion engine and a motor as a power source), a PHEV (plug-in hybrid vehicle), a BEV (battery electric vehicle), a FCEV (fuel cell vehicle), and the like.

The riding capacity information can include the riding capacity of the vehicle currently used by the user, for example, numerical information such as 2, 4, 5, 6, 7, 8, and 10. Alternatively, information that can specify the number of front seats/rear seats that can be seated and the number of front seats/second seats/third seats that can be seated, such as 2/3, 2/2/3, and the like, can be included.

The use form information can include information that can identify what purpose and form the user often uses the vehicle currently used by the user, such as short distance, commuting, leisure, and long distance drive.

The ADAS information can include information that can identify what driving support function and safety function the vehicle currently used by the user has. As an example, it is possible to include information that can specify a function, such as ACC (Adaptive Cruise Control: a vehicle speed control system that automatically performs acceleration and deceleration while maintaining an inter-vehicle distance from a preceding vehicle), a LDW (Lane Departure Warning), a LKAS (Lane Keep Assist System), a RCTA (Rear Cross Traffic Alert: a system that detects a vehicle that crosses behind when the vehicle is moving backward to call driver's attention), a CMBS (Collision Mitigation Braking System), or a PPS (Pedestrian Protection System).

The information regarding the residence of the user may include information that can specify:

in apartment building, the presence/absence of a parking lot, the presence/absence of a charging facility for BEV; and

in a detached house, the presence/absence of a parking lot, the presence/absence of a charging facility for BEV, the presence/absence of V2H (Vehicle to Home: a system in which electric power stored in a battery of a BEV or a PHEV can be used at home).

The information regarding the chatbot use history can include questions, answers, and session information. The question information may include information that can specify what content of the question has been from the user when the chatbot session has been opened, including how many technical terms (vocabulary). The answer information may include information that can specify the breadth of the range of the vocabulary, the amount of information, and the type of information. The session information may include information that can specify a degree of user assessment and comprehension of the answer from the chatbot, a start time and an end time of the chatbot session, and the like.

The information regarding the amount of knowledge is information used when determining how many technical terms (vocabulary), description complexity, and description length to output the answer of the chatbot for a question related to the vehicle. The information regarding the amount of knowledge is referred to for sufficient explanation to the extent that the user can easily understand and does not feel redundant.

The amount of knowledge of the user changes depending on the length of the period from the start of holding the vehicle and experience. Therefore, it is desirable that the information regarding the amount of knowledge is configured to be updatable at any time. For example, it is possible to update the information regarding the amount of knowledge regarding the vehicle of the user by referring to the session information accumulated by the user repeating the interaction with the chatbot. For example, in the middle of a chatbot session or at the end of the session, the user may give feedback input such as “I want a simpler description by reducing technical terms of description” or “I want a more detailed description by increasing technical terms”, and the session information may be generated according to the input result. Accordingly, the information regarding the amount of knowledge can be updated.

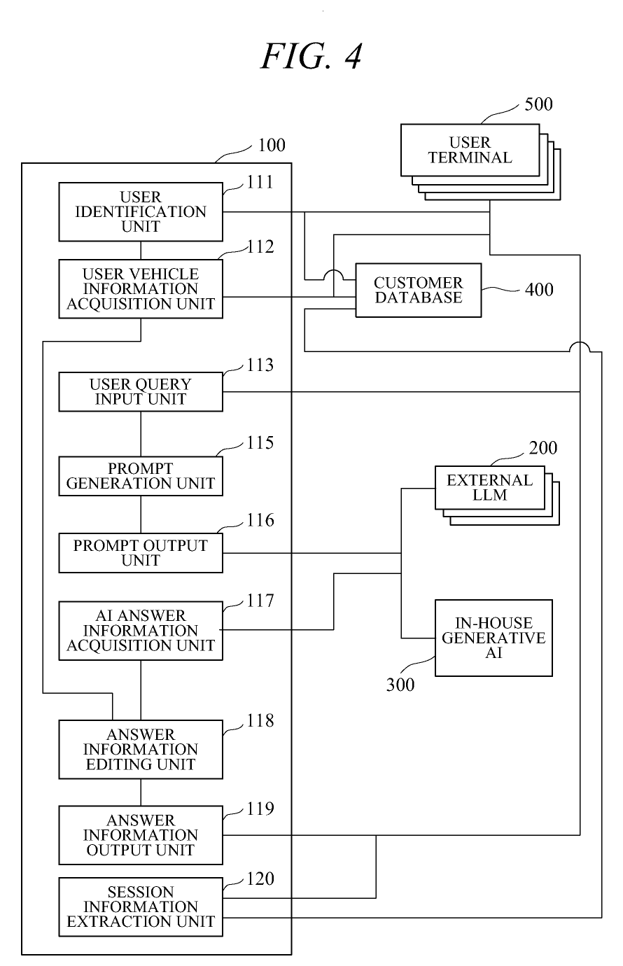

FIG. 4 is a block diagram for explaining a chatbot processing unit realized by the CPU 101 of the server 100 executing a chatbot program, and is a diagram illustrating an external element connected to the server 100 via the network NW.

A user identification unit 111 exchanges a user ID and a password with the user terminal 500 that is connected to the server 100 and intends to start a chatbot session, and identifies and authenticates the user based on the user ID 402 and the login information 404 acquired by accessing the customer database 400. A user vehicle information acquisition unit 112 acquires the user data 406 corresponding to the user identified by the user identification unit 111 from the customer database 400.

When the user data 406 is not registered in the customer database 400, the user vehicle information acquisition unit 112 outputs a chat for requesting a user (hereinafter, referred to as a chat user) who operates the user terminal 500 being logged in to input necessary information. In response to a question from the chatbot, the chat user inputs information (hereinafter, referred to as user vehicle information) on which the user data 406 (FIG. 3) registered in the customer database 400 is based.

A user query input unit 113 inputs a query input from the chat user. Specifically, the user query input unit 113 receives a query input by the chat user via the user terminal 500 from the user terminal 500. The user query input unit 113 outputs the query received from the user terminal 500 to a prompt generation unit 115. The query input from the chat user may be text-based or by voice input. The prompt generation unit 115 analyzes the query input from the chat user (received from the user terminal 500), and generates a prompt to be output to the external LLM 200 or the generative AI system 300. In the present embodiment, an example in which a plurality of external LLMs 200 and a generative AI system 300 are provided will be described, but only one of them may be provided as an output destination of a prompt.

In a case where a plurality of candidates is provided as output destinations of the prompt, the server 100 may determine whether to output the prompt to either the external LLM 200 or the generative AI system 300 according to the query from the chat user and the user vehicle information specific to the chat user, and the prompt generation unit 115 may generate an input sentence corresponding to the output destination.

A prompt output unit 116 outputs the input sentence generated by the prompt generation unit 115, that is, the prompt, to any output destination determined by the server 100.

An AI answer information acquisition unit 117 receives an answer from the external LLM 200 or the generative AI system 300 to which the prompt output unit 116 has output the prompt. In the present specification, the answer received by the AI answer information acquisition unit 117 from the external LLM 200 or the generative AI system 300 as the output destination of the prompt is referred to as an original answer.

An answer information editing unit 118 performs editing processing on the original answer acquired by the AI answer information acquisition unit 117 based on the user data 406 specific to the chat user acquired by the user vehicle information acquisition unit 112, and generates answer information which is information to be presented to the chat user.

More specifically, the answer information editing unit 118 performs editing processing as follows. That is, the amount of knowledge related to the vehicle of the chat user is determined based on the information regarding the amount of knowledge and the chatbot use history described with reference to FIG. 3, and it is determined at what level of detail the information is provided, what level of technical terms the information is provided (range of vocabulary), and what type of information is provided. Alternatively or in addition, with reference to the information of the vehicle possession history of the user, the amount of knowledge related to the vehicle of the chat user can be determined, and at what level of detail the information is provided, what level of technical terms the information is provided (range of vocabulary), and what type of information is provided can be determined.

For example, it is assumed that there is a question from the chat user with an expression "I want to know how to use the function of running at a constant speed, and when the distance to the vehicle running ahead is approaching, reducing the speed to follow the vehicle running ahead." instead of an expression including technical terms such as “I want to know how to use the ACC function”. At this time, since the information regarding the amount of knowledge of the chat user corresponds to a beginner, and no question is made using the technical term ACC, the answer information editing unit 118 determines that the chat user is not familiar with the technical term. Based on this determination, the answer information editing unit 118 can perform editing processing on the original answer by replacing the technical term ACC with plain words.

Further, it is possible to determine a range of vocabulary and a type of information to be provided with reference to information of a driving system of a vehicle currently used by the chat user, a vehicle body shape, a motor, a riding capacity, a use form, and an ADAS to be equipped. For example, it is assumed that there is a question "I want to know how to use LKAS" from the chat user. As a result of referring to the user data 406 specific to the chat user, when the vehicle owned by the chat user has the function of the LKAS, the answer information editing unit 118 can omit the description of the function of the LKAS in the original answer, and can perform the editing processing so as to generate answer information specialized in a specific operation method of setting/canceling the LKAS in the vehicle owned by the chat user.

In addition, it is assumed that a question from the chat user is a question “I want to know about the charging facility of the BEV”. Then, it is assumed that, as a result of referring to the user data 406 specific to the chat user, it is determined that the chat user lives in an apartment building with a parking lot and does not have a charger, based on the information regarding the residence of the chat user. The answer information editing unit 118 can perform the editing processing so as to reduce or omit the information regarding the home charging facility in the original answer and generate answer information in which at least one of the range of vocabulary and the type of information is limited to the information regarding the charging facility located near the residence of the chat user.

Furthermore, in a case where there is a plurality of types of questions from the chat user, the answer information may be generated based on the credibility of the original answer corresponding to each question received from the large language models 200 and 300. For example, the original answer assumed to have low credibility may not be used for generating the answer information. Specifically, in a case where a plurality of types of questions includes a question in a field that the large language models 200 and 300 are not good at, the original answer corresponding to the question may not be used for generation of the answer information. For example, in a case where the chat user asks a question "Tell me the total length, the total width, and the detection range of the radar used for ACC" about a specific vehicle, there is a case where the large language models 200 and 300 do not have information regarding the detection range of the radar. In this case, the original answer corresponding to the detection range of the radar may not be used for generating the answer information.

As described above, it is possible to generate the answer information according to at least one of the amount of knowledge related to the vehicle of the user, the vehicle possession history of the user, the vehicle use situation of the user, and the vehicle possession situation of the user based on the user data 406. Specifically, it is possible to generate the answer information while changing at least one of the breadth of the range of the vocabulary of the answer information, the amount of information, and the type of information based on at least one of the pieces of information.

An answer information output unit 119 outputs the answer information edited by the answer information editing unit 118 to the user terminal 500.

When one chatbot session ends, a session information extraction unit 120 extracts information that can specify a query and an answer exchanged with the user terminal 500 within the chatbot session, information regarding evaluation from the chat user for an answer from the chatbot, information that can specify a degree of understanding of the chat user, and information that can specify when the chatbot session starts and ends, and adds the extracted information to the user data 406 in the customer database 400.

At this time, in a case where it is determined that the amount of knowledge of the chat user increases as the number of times of use of the chatbot session by the chat user increases, the session information extraction unit 120 may update the information regarding the amount of knowledge in the user data 406. Alternatively, the session information extraction unit 120 may update the above-described information regarding the amount of knowledge in response to a feedback by the chat user during the chatbot session, for example, a request such as "Please add more technical terms and simplify the description".

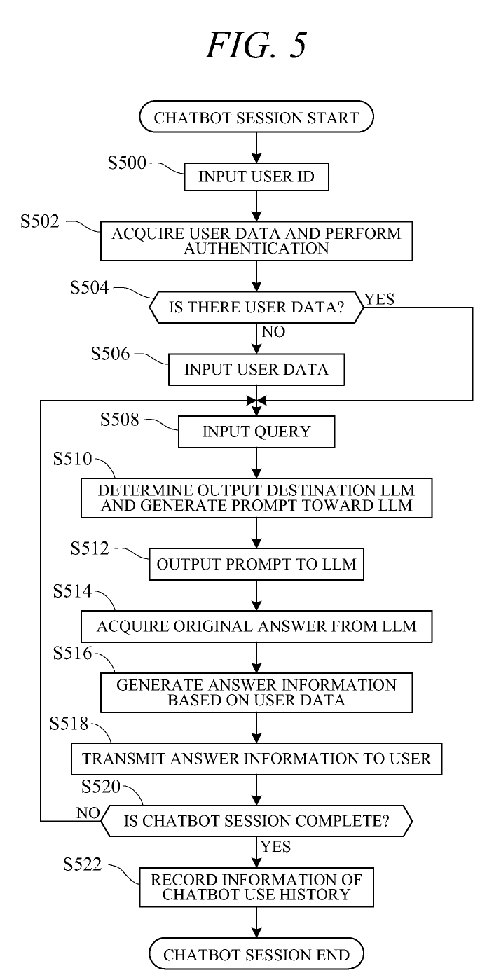

FIG. 5 is a flowchart for explaining a flow of chatbot response processing executed by the CPU 101 of the server 100. When the chat user operates the user terminal 500 to start the chatbot session, the CPU 101 acquires the user ID from the user terminal 500 in S500.

In S502, the CPU 101 accesses the customer database 400 to acquire the login information 404 and the user data 406 corresponding to the login ID of the chat user. Then, the CPU 101 performs authentication processing by collating the password information included in the login information 404 with the password input from the chat user.

In S504, the CPU 101 determines the presence or absence of the user data 406 specific to the chat user in the customer database 400. In a case where there is no user data 406 in S504, a negative determination is made, and the process proceeds to S506. The CPU 101 performs user data input processing in S506. In the processing of the user data input, the CPU 101 outputs, to the user terminal 500, a chat that prompts the chat user to input information that is the basis of the user data 406. Alternatively, another screen may be opened to request the chat user to input information. For a chat user who does not have time to input an answer to the question from the chatbot side, skips the input of the answer, and needs information from the chatbot in a hurry, the chat user may be caused to input only the amount of knowledge regarding the vehicle which is recognized by the chat user.

On the other hand, in a case where there is the user data in S504, an affirmative determination is made, and the process proceeds to S508. In S508, the CPU 101 inputs the query uttered by the chat user. Specifically, the CPU 101 receives, from the user terminal 500, a query input by the chat user via the user terminal 500. In S510, the CPU 101 analyzes the content of the query from the chat user input (received from the user terminal 500) in S508, determines an LLM to which a prompt is output, and generates a prompt to output toward the LLM. If there is only one LLM connected to the server 100, the process of determining the output destination LLM can be omitted.

As a method of determining the LLM to which the prompt is output, it is possible to determine the LLM based on the field of specialization for each LLM, the level of detail required for the answer sentence, and the like. Here, it is assumed that the content of the query relates to a vehicle owned by the chat user. Then, it is assumed that the vehicle owned by the user is a product of a company that provides a chatbot service. In such a case, the generative AI system 300 can also be determined as the output destination of the prompt. By doing so, more accurate information can be provided to the chat user.

In S512, the CPU 101 outputs a prompt to the output destination LLM determined in S510, and acquires an answer output from the LLM in response to the prompt in S514. Hereinafter, the answer acquired from the LLM (including the in-house generative AI system) as the output destination of the prompt is referred to as an original answer.

In S516, the CPU 101 performs the editing processing on the original answer obtained in S514 based on the user data obtained in S502 or S506, and generates answer information to be transmitted to the chat user. That is, the function of the answer information editing unit 118 described with reference to FIG. 4 is executed. As a result, it is possible to generate the answer information while changing at least one of the breadth of the range of the vocabulary of the answer information, the amount of information, and the type of the information based on at least one of the amount of knowledge related to the vehicle of the user, the vehicle possession history of the user, the vehicle use situation of the user, and the vehicle possession situation of the user based on the user data 406.

In S518, the CPU 101 transmits the answer information generated in S516 to the user terminal 500 possessed by the chat user.

In S520, the CPU 101 determines whether the chatbot session has been completed. In a case where a further query is input from the chat user in S520, a negative determination is made, and the process returns to S508 to continue the series of processes in S508 to S520 described above. That is, the chatbot session is continued. On the other hand, in a case where no further query is input from the chat user even after a lapse of a certain period of time in S520, or in a case where an operation to end the session is received from the chat user, an affirmative determination is made, and the CPU 101 records the information of the chatbot use history in S522. The information of the chatbot use history includes the information extracted by the session information extraction unit 120 described with reference to FIG. 4. When the processing in S522 is completed, the CPU 101 enters a standby state until a new chatbot session is started.

The example in which the original answer output from the external LLM 200 or the generative AI system 300 is edited based on the user data 406 of the chat user has been described above. In this regard, it is also possible to refer to the user data 406 when the CPU 101 generates a prompt to be output to the external LLM 200 or the generative AI system 300 based on the query received from the user terminal 500 operated by the chat user, and generate a prompt such that the original answer corresponding to the user data 406 can be easily obtained. By doing so, it is possible to obtain the answer information in which at least one of the breadth of the range of the vocabulary of the answer information, the amount of information, and the number of types of information has been changed based on at least one of the amount of knowledge related to the vehicle of the user, the vehicle possession history of the user, the vehicle use situation of the user, and the vehicle possession situation of the user based on the user data 406.

Furthermore, an example in which the server 100 providing the chatbot service and the chat user operating the user terminal 500 directly exchange with each other has been described above, but an operator may intervene. For example, the operator may receive a question from the chat user via a terminal operated by the operator, and output a prompt to the external LLM 200 or the generative AI system 300 via the terminal. In this case, the answer result from the external LLM 200 or the generative AI system can be presented to the operator via the answer information editing unit 118. The operator can reply to the customer with reference to the presented answer result.

According to the present embodiment, the following operations and effects are achievable.

(1) The chatbot program is stored in a storage medium readable by the computer 100 (FIG. 1). The chatbot program causes the computer 100 to execute acquiring, from a database (user-specific information storage unit) 400 (FIGS. 1 and 4), user-specific information 406 (FIGS. 2 and 3) that is vehicle information specific to the user, receiving, from a user terminal 500 (FIG. 1) operated by the user, a query related to the vehicle input by the user via the user terminal (S508 in FIG. 5), generating answer information (S510, S512, S514, and S516 in FIG. 5), in which a prompt that is an input sentence for the large language models 200 and 300 is generated and transmitted to the large language models 200 and 300 based on the query, an original answer to the prompt is received from the large language models 200 and 300, and the answer information is generated while changing at least one of the breadth of the range of vocabulary of the answer information, the amount of information, and the type of information based on at least one of the amount of knowledge related to the vehicle of the user, the vehicle possession history of the user, the vehicle use situation of the user, and the vehicle possession situation of the user based on the user-specific information 406 (FIG. 3), and transmitting the answer information to the user terminal 500.

According to this, it is possible to transmit an answer that is easy for the user to understand and is difficult for the user to feel redundant to the user terminal according to the background specific to the user, such as the amount of knowledge related to the vehicle of the user, the vehicle possession history of the user, the vehicle use situation of the user, and the vehicle possession situation of the user.

(2) In a case where the user-specific information 406 does not exist in the user-specific information storage unit 400, the chatbot program further causes the computer 100 to execute outputting, to the user, a message prompting the user to input the user-specific information (S506 in FIG. 5).

Accordingly, even when the user-specific information 406 does not exist in the user-specific information storage unit, an accurate answer can be transmitted to the user.

(3) In the chatbot program, answer information in which the breadth of the range of the vocabulary is expanded and/or the amount of information is reduced as the vehicle possession period of the user is longer is generated based on the user-specific information 406 (S516 in FIG. 5).

According to this, it is possible to transmit an accurate answer to a user assumed to have a long vehicle possession period and a corresponding amount of knowledge.

(4) In the chatbot program, based on the user-specific information 406, answer information is generated that narrows the range of the vocabulary related to the electric vehicle if the user does not have a history of possession of the electric vehicle and/or reduces the amount of information regarding the electric vehicle (S516 in FIG. 5).

This makes it possible to reduce information including a vocabulary that is not familiar to a user who has never owned an electric vehicle and information that is difficult to understand, and transmit an answer that is easy for the user to understand.

(5) In the chatbot program, in a case where a matter related to charging of the electric vehicle is included in the query, information regarding the residence of the user is extracted based on the user-specific information 406, and answer information in which at least one of the breadth of the range of the vocabulary, the amount of information, and the type of information is changed is generated based on the information regarding the residence of the user (S510, S512, S514, and S516 in FIG. 5).

According to this, it is possible to provide information appropriate to the residence form of the user.

(6) The server 100 as a chatbot apparatus includes a user vehicle information acquisition unit 112 (FIG. 4) that acquires user-specific information 406 (FIGS. 2 and 3), which is vehicle information specific to the user, from a user-specific information storage unit 400 (FIGS. 1 and 4), a user query input unit 113 that receives a query related to the vehicle input by the user via the user terminal from the user terminal operated by the user, an answer information generation unit (115, 116, 117, 118 in FIG. 4) that generates a prompt, which is an input sentence for the large language models 200 and 300, based on the query and transmits the prompt to the large language models 200 and 300, receives an original answer to the prompt from the large language models 200 and 300, and when answer information to be transmitted to the user terminal 500 is generated based on the original answer, generates the answer information while changing a degree of at least one of the range of vocabulary of the answer information, the amount of information, and the type of information based on at least one of the amount of knowledge related to the vehicle of the user, the vehicle possession history of the user, the vehicle use situation of the user, and the vehicle possession situation of the user based on the user-specific information 406 (FIG. 3), and an answer information output unit 119 that transmits the answer information to the user terminal.

According to this, it is possible to provide a chatbot apparatus capable of transmitting an answer that is easy for the user to understand and is difficult to feel redundant to the user terminal according to a background specific to the user, such as the amount of knowledge related to the vehicle of the user, a vehicle possession history of the user, a vehicle use situation of the user, and a vehicle possession situation of the user.

The above embodiment can be combined as desired with one or more of the aforesaid modifications. The modifications can also be combined with one another.

According to the present disclosure, it is possible to provide an answer suitable for an individual user from a chatbot system.

Above, while the present invention has been described with reference to the preferred embodiments thereof, it will be understood, by those skilled in the art, that various changes and modifications may be made thereto without departing from the scope of the appended claims.

What is claimed is:

1. A non-transitory computer-readable storage medium storing a chatbot program configured to be executed by a computer, wherein
the chatbot program causes the computer to perform:
acquiring, from a database, user-specific information related to a vehicle and specific to a user;
receiving, from a user terminal operated by the user, a query related to the vehicle input by the user via the user terminal;
generating a prompt being an input sentence for a large language model to transmit to the large language model based on the query;
receiving an original answer to the prompt from the large language model;
generating answer information based on the original answer; and
transmitting the answer information to the user terminal, wherein
the generating the answer information includes generating the answer information based on the user-specific information while changing at least one of a breadth of a range of vocabulary, an amount, and a type of the answer information based on at least one of an amount of knowledge related to the vehicle of the user, a vehicle possession history of the user, a vehicle use situation of the user, and a vehicle possession situation of the user.

2. The storage medium according to claim 1, wherein
the chatbot program further causes the computer to perform:
in a case where the user-specific information does not exist in the database, outputting, to the user terminal, a message prompting the user to input the user-specific information.

3. The storage medium according to claim 2, wherein
the generating the answer information includes, based on the user-specific information, generating the answer information in which, as a vehicle possession period of the user is longer, the breadth of the range of the vocabulary is expanded and/or the amount of information is reduced.

4. The storage medium according to claim 2, wherein
the generating the answer information includes, based on the user-specific information, generating the answer information in which, if the user does not have a history of possession of an electric vehicle, the range of the vocabulary related to the electric vehicle is narrowed and/or the amount of information regarding the electric vehicle is reduced.

5. The storage medium according to claim 2, wherein
the generating the answer information includes:
in a case where a matter related to charging of an electric vehicle is included in the query, extracting information regarding a residence of the user based on the user-specific information, and
changing at least one of the breadth of the range of the vocabulary, the amount of information, and the type of the answer information based on the information regarding the residence to generate the answer information.

6. A chatbot apparatus comprising:
a microprocessor; and
a memory connected to the microprocessor, wherein
the microprocessor is configured to perform:
acquiring, from a database, user-specific information related to a vehicle and specific to a user;
receiving, from a user terminal operated by the user, a query related to the vehicle input by the user via the user terminal;
generating a prompt being an input sentence for a large language model to transmit to the large language model based on the query;
receiving an original answer to the prompt from the large language model;
generating answer information based on the original answer; and
transmitting the answer information to the user terminal, wherein
the microprocessor is configured to perform:
the generating the answer information including generating the answer information based on the user-specific information while changing at least one of a breadth of a range of vocabulary, an amount, and a type of the answer information based on at least one of an amount of knowledge related to the vehicle of the user, a vehicle possession history of the user, a vehicle use situation of the user, and a vehicle possession situation of the user.
